(19) United States
(12) Patent Application Publication
(10) Pub. No.: US 2026/0326221 A1
(43) Pub. Date: Oct. 22, 2026

(54) MACHINE TOOL AND GEAR MACHINING METHOD

(71) Applicant: NIDEC MACHINE TOOL CORPORATION, Ritto (JP)

(72) Inventors: Kazuyuki ISHIZU, Ritto-shi (JP); Satoshi HIRATA, Ritto-shi (JP)

(73) Assignee: NIDEC MACHINE TOOL CORPORATION, Ritto (JP)

(21) Appl. No.: 19/647,181

(22) Filed: Apr. 14, 2026

(30) Foreign Application Priority Data
Apr. 16, 2025 (JP) 2025-067651

(51) Int. Cl. B23F 9/08

(52) U.S. Cl. CPC B23F 9/082

(57) ABSTRACT

A machine tool of the present disclosure is a machine tool that chamfers a plurality of tooth profiles included in a gear, and includes a tool including a plurality of cutting edges, a gear drive unit that holds the gear so as to be rotatable about a gear axis extending in a first direction, a tool drive unit that holds the tool so as to be rotatable about a tool axis extending in a second direction intersecting the first direction, and a control unit that controls operation of each of the tool drive unit and the gear drive unit. The gear and the tool face each other in a third direction intersecting both the first direction and the second direction. The tool drive unit can move the tool in the third direction. When chamfering the tooth profile, the control unit changes a position of the tool in the third direction with respect to the gear by the tool drive unit while changing a ratio of a rotation speed of the gear to a rotation speed of the tool by at least one of the tool drive unit and the gear drive unit.

### CROSS-REFERENCE TO RELATED APPLICATIONS

The present invention claims priority under 35 U.S.C. § 119 to Japanese Patent Application No. 2025-067651 filed on Apr. 16, 2025, the entire content of which is incorporated herein by reference.

### TECHNICAL FIELD

The present disclosure relates to a machine tool and a gear machining method.

### BACKGROUND

Chamfering tools are known which have a plurality of teeth and are used for chamfering a toothed workpiece.

In a case of chamfering an end surface of a workpiece having a tooth profile having a curved shape such as an involute gear and a ridge line part of a tooth flank, for example, by a machine tool including the above chamfering tool, when the tooth profile is chamfered in a state where a position of the chamfering tool with respect to a workpiece gear is fixed, it is difficult to achieve uniformity of a chamfer amount from a tooth root to a tooth tip of the tooth profile.

### SUMMARY

An aspect of a machine tool of the present disclosure is a machine tool that chamfers a plurality of tooth profiles included in a gear, the machine tool including a tool including a plurality of cutting edges, a gear drive unit configured to hold the gear so as to be rotatable about a gear axis extending in a first direction, a tool drive unit configured to hold the tool so as to be rotatable about a tool axis extending in a second direction intersecting the first direction, and a control unit configured to control operation of each of the tool drive unit and the gear drive unit. The gear and the tool face each other in a third direction intersecting both the first direction and the second direction. The tool drive unit can move the tool in the third direction. When chamfering the tooth profile, the control unit changes a position of the tool in the third direction with respect to the gear by the tool drive unit while changing a ratio of a rotation speed of the gear to a rotation speed of the tool by at least one of the tool drive unit and the gear drive unit.

An aspect of a gear machining method of the present disclosure is a gear machining method that chamfers a plurality of tooth profiles included in a gear by a machine tool including a tool including a plurality of cutting edges, a gear drive unit that holds the gear so as to be rotatable about a gear axis extending in a first direction, a tool drive unit that holds the tool so as to be rotatable about a tool axis extending in a second direction intersecting the first direction, and a control unit that controls operation of each of the tool drive unit and the gear drive unit. The gear and the tool face each other in a third direction intersecting both the first direction and the second direction. The control unit changes a position of the tool in the third direction with respect to the gear by the tool drive unit while changing a ratio of a rotation speed of the gear to a rotation speed of the tool by at least one of the tool drive unit and the gear drive unit.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a side view illustrating a machine tool of one embodiment;

FIG. 2 is a top view illustrating the machine tool of the embodiment;

FIG. 3 is a perspective view illustrating a tool of the embodiment;

FIG. 4 is a perspective view illustrating a gear of the embodiment;

FIG. 5 is a first flowchart illustrating a gear machining method of the embodiment;

FIG. 6 is a second flowchart illustrating the gear machining method of the embodiment;

FIG. 7 includes timing charts showing the gear machining method of the embodiment;

FIG. 8 is a first perspective view illustrating the gear machining method of the embodiment;

FIG. 9 is a first perspective view illustrating the gear in the gear machining method of the embodiment;

FIG. 10 is a second perspective view illustrating the gear machining method of the embodiment;

FIG. 11 is a second perspective view illustrating the gear in the gear machining method of the embodiment;

FIG. 12 is a third perspective view illustrating the gear machining method of the embodiment;

FIG. 13 is a third perspective view illustrating the gear in the gear machining method of the embodiment;

FIG. 14 is a flowchart illustrating the gear machining method of a modification of the embodiment; and

FIG. 15 includes timing charts showing the gear machining method of the modification of the embodiment.

### DETAILED DESCRIPTION

Hereinafter, a machine tool and a gear machining method according to an embodiment of the present disclosure will be described with reference to the drawings. The scope of the present disclosure is not limited to the following embodiments, and can be optionally changed within the scope of the technical idea of the present disclosure. In addition, in the following drawings, scales, numbers, and the like may differ from those of the actual structure in order to facilitate understanding of each configuration.

A first direction D1 is appropriately indicated in each drawing. The first direction D1 is a direction in which a gear axis J2, which is a central axis of a gear, extends. The gear axis J2 is a virtual axis. In the present embodiment, the first direction D1 is a vertical direction. The first direction D1 may be a direction intersecting the vertical direction. In the following description, a side toward which an arrow of the first direction D1 points (+D1 side) is referred to as an “upper side”. A side opposite to the side toward which the arrow of the first direction D1 points (−D1 side) is referred to as a “lower side”.

A second direction D2 is appropriately indicated in each drawing. The second direction D2 is a direction in which a tool axis J1, which is a central axis of a tool, extends. The tool axis J1 is a virtual axis. The second direction D2 is a direction intersecting the first direction D1. In the present embodiment, the second direction D2 is a direction orthogonal to the first direction D1. The second direction D2 need not be orthogonal to the first direction D1. In the following description, a side toward which an arrow of the second direction D2 points (+D2 side) is referred to as “one side in the second direction D2”. A side opposite to the side toward which the arrow of the second direction D2 points (−D2 side) is referred to as “another side in the second direction D2”.

A third direction D3 is appropriately indicated in each drawing. The third direction D3 is a direction intersecting both the first direction D1 and the second direction D2. In the present embodiment, the third direction D3 is a direction orthogonal to both the first direction D1 and the second direction D2. The third direction D3 need not intersect at least one of the first direction D1 and the second direction D2. In the following description, a side toward which an arrow of the third direction D3 points (+D3 side) is referred to as “one side in the third direction”. A side opposite to the side toward which the arrow of the third direction D3 points (−D3 side) is referred to as “another side in the third direction D3”.

### EMBODIMENT

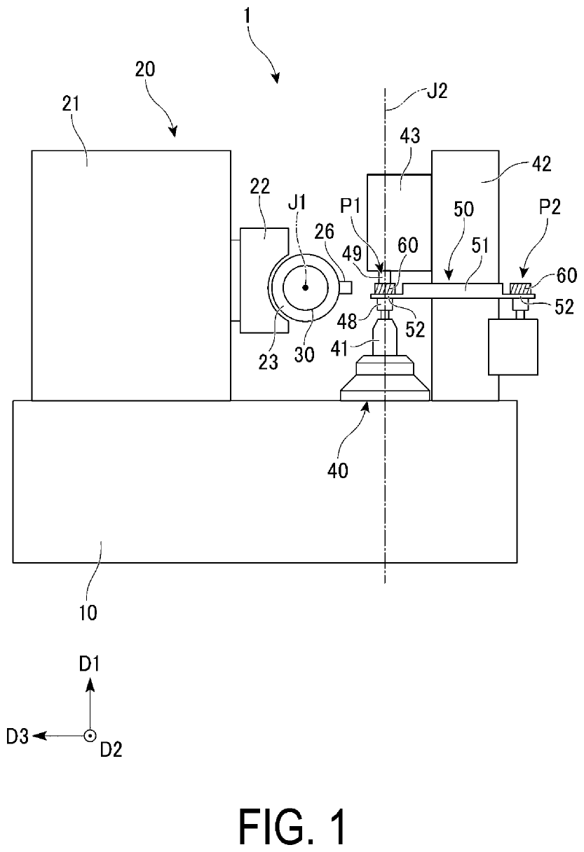

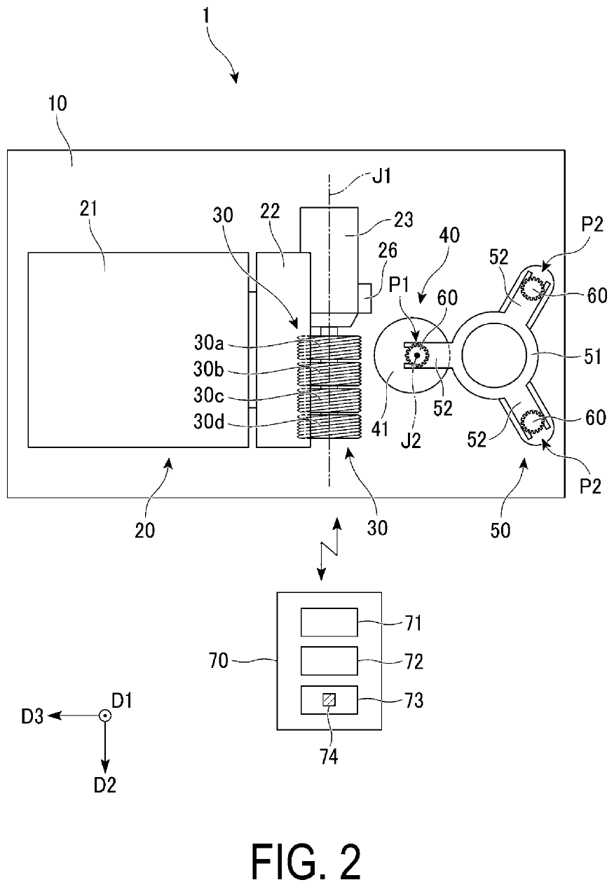

FIG. 1 is a side view illustrating a machine tool 1 of the present embodiment. FIG. 2 is a top view illustrating the machine tool 1 of the present embodiment. The machine tool 1 of the present embodiment is a machine tool that chamfers a plurality of tooth profiles 63 included in a gear 60, which is a workpiece. As illustrated in FIG. 1, the machine tool 1 includes a bed 10, a tool drive unit 20, a phase sensor 26, a tool 30, a gear drive unit 40, and a changer 50. As illustrated in FIG. 2, the machine tool 1 includes a control unit 70.

The bed 10 illustrated in FIG. 1 is a support base that supports the tool drive unit 20 and the gear drive unit 40. The bed 10 is implemented using parts made of metal. The bed 10 is installed on a floor of a factory where the plurality of tooth profiles 63 included in the gear 60 are chamfered. The bed 10 has a substantially rectangular parallelepiped shape. Each of the tool drive unit 20 and the gear drive unit 40 is fixed to a surface of the bed 10 facing the upper side. The bed 10 supports each of the tool drive unit 20 and the gear drive unit 40 from the lower side. The tool drive unit 20 is disposed on the one side (+D3 side) in the third direction D3 with respect to the gear drive unit 40. As illustrated in FIG. 2, the tool drive unit 20 faces the gear drive unit 40 with an interval in the third direction D3.

The tool drive unit 20 is a mechanism that holds the tool 30, and moves and rotates the tool 30. More specifically, the tool drive unit 20 can move the tool 30 in each of the first direction D1, the second direction D2, and the third direction D3. Further, the tool drive unit 20 can rotate the tool 30 about the tool axis J1. Therefore, the tool drive unit 20 holds the tool 30 so as to be rotatable about the tool axis J1. As illustrated in FIG. 1, the tool drive unit 20 includes a column 21, a saddle 22, and a tool head 23.

The column 21 is movable in the third direction D3 with respect to the bed 10 by a first drive mechanism (not illustrated). The saddle 22 is attached to a surface of the column 21 facing the other side (−D3 side) in the third direction D3. The saddle 22 is disposed between the column 21 and the gear drive unit 40. The saddle 22 is movable in the first direction D1 with respect to the column 21 by a second drive mechanism (not illustrated).

The tool head 23 is attached to the saddle 22. The tool head 23 is disposed between the saddle 22 and the gear drive unit 40 in the third direction D3. The tool head 23 is movable in the second direction D2 with respect to the saddle 22 by a third drive mechanism (not illustrated). The tool head 23 is rotatable about the tool axis J1 by a fourth drive mechanism (not illustrated). The tool head 23 is rotatable about a rotation axis extending in the third direction by a fifth drive mechanism (not illustrated).

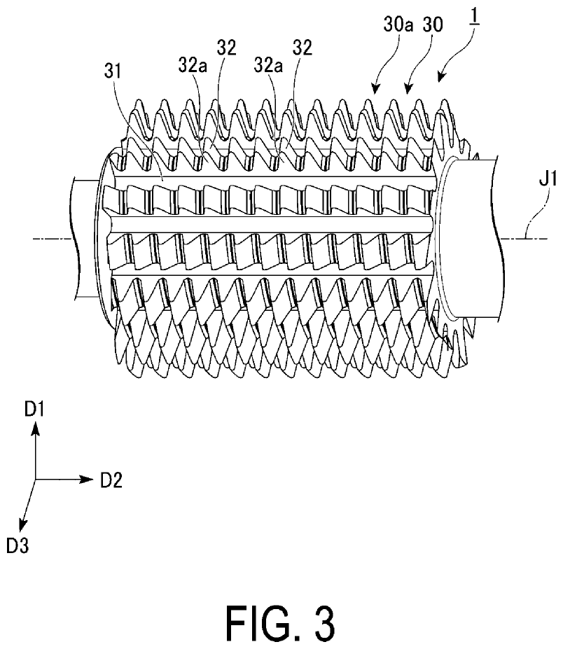

FIG. 3 is a perspective view illustrating the tool 30 of the present embodiment. The tool 30 illustrated in FIG. 3 is a cutting tool that chamfers the plurality of tooth profiles 63 included in the gear 60. In the present embodiment, the tool 30 is a hob cutter. The hob cutter is a tool that is less likely to cause secondary burrs due to chamfering and has excellent chamfering quality. The tool 30 is made of, for example, alloy such as high-speed steel or cemented carbide. The tool 30 is detachably attached to the tool head 23 illustrated in FIG. 1. In a state where the tool 30 is attached to the tool head 23, a rotary shaft of the tool head 23 and the tool axis J1 are disposed coaxially with each other. In the state where the tool 30 is attached to the tool head 23, when the first drive mechanism, the second drive mechanism, and the third drive mechanism are caused to operate, the tool 30 moves to each of the third direction D3, the first direction D1, and the second direction D2, together with the tool head 23. Further, in the state where the tool 30 is attached to the tool head 23, when the fourth drive mechanism is caused to operate, the tool 30 rotates about the tool axis J1 together with the tool head 23. The control unit 70 manages a phase of the tool 30 about the tool axis J1. Thus, the control unit 70 can perform phase alignment between the tool 30 and the gear 60, which will be described below.

As illustrated in FIG. 2, a plurality of the tools 30 is attached to the tool head 23. In the present embodiment, four tools 30 are attached to the tool head 23. The number of tools 30 attached to the tool head 23 may be three or less, or five or more. The four tools 30 include a first tool 30a, a second tool 30b, a third tool 30c, and a fourth tool 30d. The respective tools 30 are disposed side by side along the second direction D2. The tool drive unit 20 holds each tool 30 so as to be rotatable around the tool axis J1. The respective tools 30 are used to chamfer parts different from each other of each of the plurality of tooth profiles 63 of the gear 60. In the following description, a configuration of the first tool 30a will be described, but each tool 30 is similarly configured except for an orientation of a cutting surface 32a of a cutting edge 32. As illustrated in FIG. 3, the tool 30 includes a tubular portion 31 and a plurality of the cutting edges 32.

The tubular portion 31 has a substantially cylindrical shape that is centered on the tool axis J1, and extends in the second direction D2. As illustrated in FIG. 2, the rotary shaft of the tool head 23 is inserted through an inside of the tubular portion 31 in the second direction D2. The tubular portion 31 is detachably attached to the rotary shaft. Thus, the tool 30 is detachably attached to the tool head 23.

As illustrated in FIG. 3, each of the plurality of cutting edges 32 protrudes radially outward from an outer circumferential surface of the tubular portion 31 about the tool axis J1. Each cutting edge 32 has a substantially triangular shape as viewed in a circumferential direction about the tool axis J1. The respective cutting edges 32 are disposed side by side along the second direction D2. That is, the tool 30 includes the plurality of cutting edges 32 along the second direction D2. Further, the respective cutting edges 32 are disposed side by side at intervals along the circumferential direction about the tool axis J1. The respective cutting edges 32 are disposed along an entire circumference in the circumferential direction about the tool axis J1. The respective cutting edges 32 are disposed along one or more spiral paths about the tool axis J1. Each of the plurality of cutting edges 32 includes the cutting surface 32a. As described below, the respective cutting surfaces 32a come into contact with the tooth profile 63 when the plurality of tooth profiles 63 included in the gear 60 are chamfered. In the present embodiment, each cutting surface 32a is linear. Therefore, according to the present embodiment, the cutting surface 32a can be formed more easily as compared with a case where the cutting surface 32a has a curved shape with a recessed part, for example, as viewed in the circumferential direction about the tool axis J1. Thus, it is possible to suppress increases in the number of manufacturing steps and manufacturing costs for the tool 30. Note that as described above, the orientations of the cutting surfaces 32a of the respective four tools 30 are different from each other.

The gear drive unit 40 illustrated in FIG. 1 is a mechanism that holds the gear 60 so as to be rotatable about the gear axis J2. The gear drive unit 40 is disposed on the other side (−D3 side) in the third direction D3 with respect to the tool drive unit 20. The gear drive unit 40 faces the tool drive unit 20 with an interval in the third direction D3. The gear drive unit 40 includes a table 41, a counter column 42 and a tailstock 43. Note that in FIG. 2, the counter column 42 and the tailstock 43 are not illustrated.

The table 41 illustrated in FIG. 1 is a unit that supports the gear 60 from the lower side. The table 41 is fixed to the surface of the bed 10 facing the upper side. The table 41 is disposed between the column 21 and the counter column 42 in the third direction D3. A lower clamper 48 that supports the gear 60 from the lower side is provided at an upper end portion of the table 41.

The counter column 42 is fixed to the surface of the bed 10 facing the upper side. The counter column 42 extends to the upper side from the bed 10. The tailstock 43 is a unit that supports the gear 60 from the upper side. The tailstock 43 is attached to a surface of the counter column 42 facing the one side (+D3 side) in the third direction D3. The tailstock 43 is attached so as to be movable with respect to the counter column 42 in the first direction D1. The tailstock 43 is disposed on the upper side of the table 41. The tailstock 43 faces the table 41 with an interval in the first direction D1. An upper clamper 49 that supports the gear 60 from the upper side is provided at a lower end portion of the tailstock 43. The lower clamper 48 and the upper clamper 49 are rotatable about the gear axis J2 by a first rotation mechanism (not illustrated). Thus, the gear 60 is rotatable about the gear axis J2.

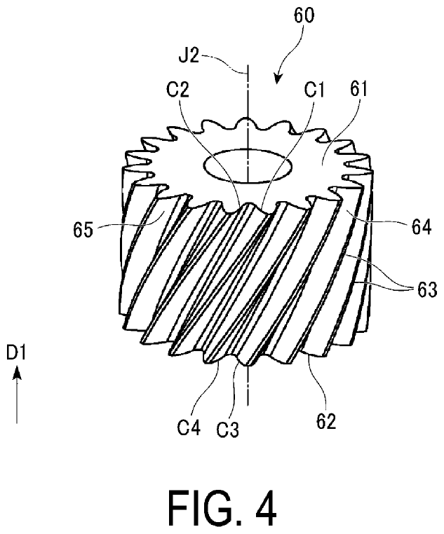

FIG. 4 is a perspective view illustrating the gear 60 of the present embodiment. As illustrated in FIG. 1, the gear 60 is clamped by the lower clamper 48 provided at the table 41 and the upper clamper 49 provided at the tailstock 43. Thus, the gear drive unit 40 holds the gear 60. The gear 60 and the tool 30 face each other in the third direction D3. The gear drive unit 40 holds the gear 60 such that the gear axis J2 faces in the vertical direction. When the first rotation mechanism operates, the gear 60 rotates about the gear axis J2. Thus, the gear drive unit 40 holds the gear 60 so as to be rotatable about the gear axis J2. As illustrated in FIG. 4, the gear 60 has a substantially circular ring shape about the gear axis J2. The gear 60 of the present embodiment is a helical gear. The gear 60 may be a spur gear. Further, the gear 60 of the present embodiment is an involute gear. The gear 60 includes a first end surface 61, a second end surface 62, and the plurality of tooth profiles 63.

The first end surface 61 is one end surface of the gear 60 in a direction parallel to the gear axis J2. In a state where the gear 60 is held by the gear drive unit 40, the first end surface 61 faces the upper side. The second end surface 62 is another end surface of the gear 60 in the direction parallel to the gear axis J2. In the state where the gear 60 is held by the gear drive unit 40, the second end surface 62 faces the lower side.

The plurality of tooth profiles 63 protrude radially outward about the gear axis J2 at an outer surface of the gear 60. As described above, in the present embodiment, the gear 60 is the helical gear. Each tooth profile 63 extends spirally in the first direction D1 about the gear axis J2. A surface of each tooth profile 63 facing the upper side constitutes a part of the first end surface 61. A surface of each tooth profile 63 facing the lower side constitutes a part of the second end surface 62. Each tooth profile 63 includes a first tooth flank 64 and a second tooth flank 65.

The first tooth flank 64 is a surface facing one side in the circumferential direction about the gear axis J2. The second tooth flank 65 is a surface facing another side in the circumferential direction about the gear axis J2. In the present embodiment, each tooth profile 63 is located farther on the other side in the circumferential direction as the tooth profile 63 extends from the second end surface 62 toward the first end surface 61. As viewed from the first end surface 61 toward the second end surface 62 along the gear axis J2, the first tooth flank 64 is an obtuse-angled surface. As viewed from the first end surface 61 toward the second end surface 62 along the gear axis J2, the second tooth flank 65 is an acute-angled surface.

The machine tool 1 of the present embodiment chamfers, by cutting work, each of a first chamfered part C1 that is an upper end part of the first tooth flank 64 of each tooth profile 63, a second chamfered part C2 that is an upper end part of the second tooth flank 65, a third chamfered part C3 that is a lower end part of the first tooth flank 64, and a fourth chamfered part C4 that is a lower end part of the second tooth flank 65. In the present embodiment, the machine tool 1 chamfers the first chamfered part C1 by the first tool 30a, chamfers the second chamfered part C2 by the second tool 30b, chamfers the third chamfered part C3 by the third tool 30c, and chamfers the fourth chamfered part C4 by the fourth tool 30d. That is, the respective tools 30 are used to chamfer parts different from each other of each of the plurality of tooth profiles 63 of the gear 60. As described above, in the present embodiment, the gear 60 is the involute gear. Therefore, as viewed from the first direction D1, each of the first chamfered part C1, the second chamfered part C2, the third chamfered part C3, and the fourth chamfered part C4 has an involute curve shape.

The changer 50 illustrated in FIG. 1 and FIG. 2 is a mechanism that conveys the gear 60. The changer 50 includes a turntable 51. As illustrated in FIG. 2, the turntable 51 includes a plurality of arms 52. In the present embodiment, the turntable 51 includes three arms 52. The number of arms 52 included in the turntable 51 may be two or less, or may be four or more. The gear 60 is held at a leading end of each arm 52 via a gripper (not illustrated). The turntable 51 is rotated about a rotary shaft extending in the first direction D1 by a second rotation mechanism (not illustrated) while holding the gear 60 at each arm 52. Thus, the changer 50 conveys the gear 60 to a machining position P1 between the table 41 and the tailstock 43 and to a standby position P2 laterally away from the machining position P1.

The phase sensor 26 is a sensor that detects a phase of rotation (rotation angle) of the gear 60. As the phase sensor 26, for example, an optical sensor such as a laser displacement meter can be used. The phase sensor 26 is attached to a surface of the tool head 23 facing the other side (−D3 side) in the third direction D3. As described above, the tool head 23 is movable in the second direction D2 with respect to the saddle 22 by the third drive mechanism (not illustrated). Therefore, the phase sensor 26 is movable in the second direction D2 with respect to the gear 60. Although not illustrated, when the gear 60 rotates about the gear axis J2 in a state where the phase sensor 26 and the gear 60 face each other in the third direction D3, each tooth profile 63 of the gear 60 sequentially passes through a detection position of the phase sensor 26. Thus, the phase sensor 26 outputs a detection signal corresponding to the phase of the rotation of the gear 60.

The control unit 70 is a control device that controls operation of respective units of the machine tool 1 such as the tool drive unit 20 and the gear drive unit 40. The control unit 70 can communicate with the respective units of the machine tool 1 such as the tool drive unit 20 and the gear drive unit 40. The control unit 70 may be capable of communicating with the respective units of the machine tool 1 such as the tool drive unit 20 and the gear drive unit 40 via a wired communication means such as a cable, or may be capable of communicating via a wireless communication means such as a wireless LAN. The control unit 70 is, for example, a computer including a processor 71 such as a CPU, a memory 72 such as a RAM, and a storage unit 73 such as a hard disk drive. The storage unit 73 stores a computer program 74 for controlling the operation of each unit of the machine tool 1.

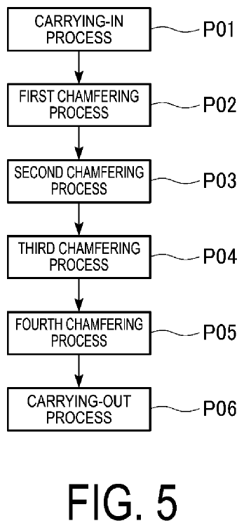

FIG. 5 is a first flowchart illustrating a gear machining method of the present embodiment. Next, the gear machining method of the present embodiment will be described. The gear machining method of the present embodiment is a machining method of chamfering the plurality of tooth profiles 63 included in the gear 60 which is a workpiece by the machine tool 1. As illustrated in FIG. 5, the gear machining method of the present embodiment includes a carrying-in process P01, a first chamfering process P02, a second chamfering process P03, a third chamfering process P04, a fourth chamfering process P05, and a carrying-out process P06. Each process described above is performed by the control unit 70 controlling the operation of each of the first drive mechanism, the second drive mechanism, the third drive mechanism, the fourth drive mechanism, the fifth drive mechanism, the first rotation mechanism, the second rotation mechanism (not illustrated), and the phase sensor 26 according to the computer program 74.

In the carrying-in process P01, the control unit 70 carries the gear 60 into the machining position P1. The control unit 70 causes the second rotation mechanism (not illustrated) to operate to rotate the changer 50 about a rotary shaft extending in the first direction D1, thereby carrying the gear 60 from the standby position P2 into the machining position P1 illustrated in FIG. 2. As illustrated in FIG. 1, the gear 60 carried into the machining position P1 is held by the lower clamper 48 and the upper clamper 49 so as to be rotatable about the gear axis J2.

In the first chamfering process P02 illustrated in FIG. 5, the control unit 70 controls the operation of each of the first drive mechanism, the second drive mechanism, the third drive mechanism, the fourth drive mechanism, the fifth drive mechanism, and the first rotation mechanism (not illustrated), to chamfer the first chamfered part C1 of each tooth profile 63 by the first tool 30a.

In the second chamfering process P03, the control unit 70 controls the operation of each of the first drive mechanism, the second drive mechanism, the third drive mechanism, the fourth drive mechanism, the fifth drive mechanism, and the first rotation mechanism (not illustrated), to chamfer the second chamfered part C2 of each tooth profile 63 by the second tool 30b.

In the third chamfering process P04, the control unit 70 controls the operation of each of the first drive mechanism, the second drive mechanism, the third drive mechanism, the fourth drive mechanism, the fifth drive mechanism, and the first rotation mechanism (not illustrated), to chamfer the third chamfered part C3 of each tooth profile 63 by the third tool 30c.

In the fourth chamfering process P05, the control unit 70 controls the operation of each of the first drive mechanism, the second drive mechanism, the third drive mechanism, the fourth drive mechanism, the fifth drive mechanism, and the first rotation mechanism (not illustrated), to chamfer the fourth chamfered part C4 of each tooth profile 63 by the fourth tool 30d. When the fourth chamfering process P05 is ended, the chamfering of each tooth profile 63 is ended.

In the carrying-out process P06, the control unit 70 carries out the gear 60 to the standby position P2. The control unit 70 causes the second rotation mechanism (not illustrated) to operate to rotate the changer 50 about the rotary shaft extending in the first direction D1, thereby carrying out the gear 60 from the machining position P1 to the standby position P2 illustrated in FIG. 2. The gear 60 carried out to the standby position P2 is removed from the arm 52 by an operator or the like. When the operator or the like removes the gear 60 from the arm 52, the chamfering of the gear 60 is ended.

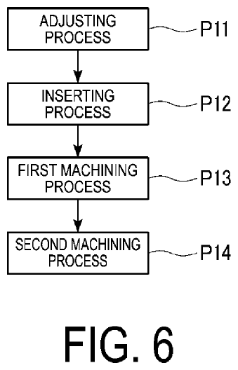

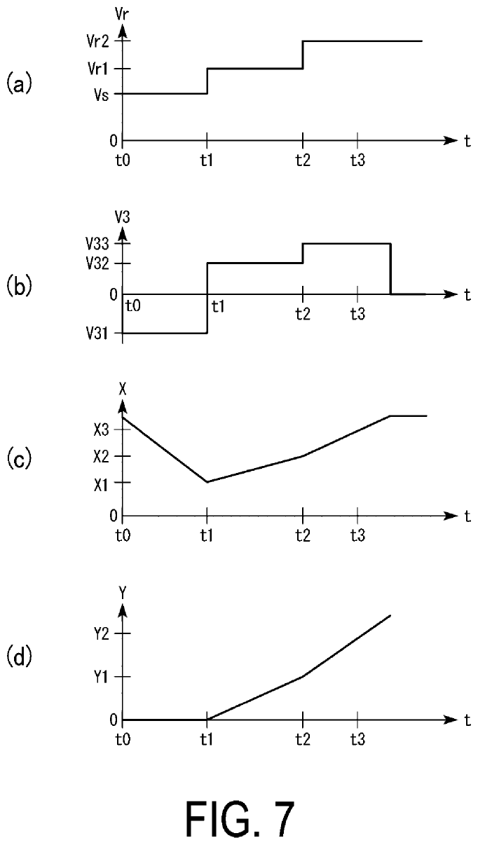

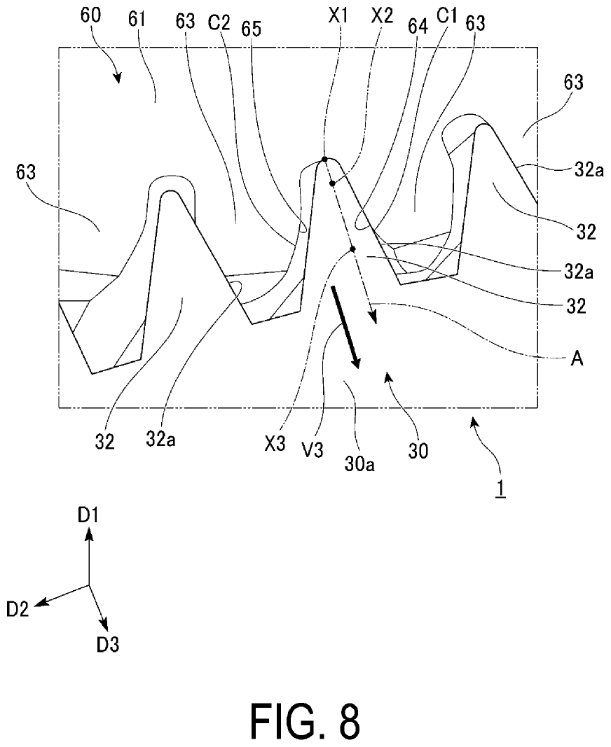

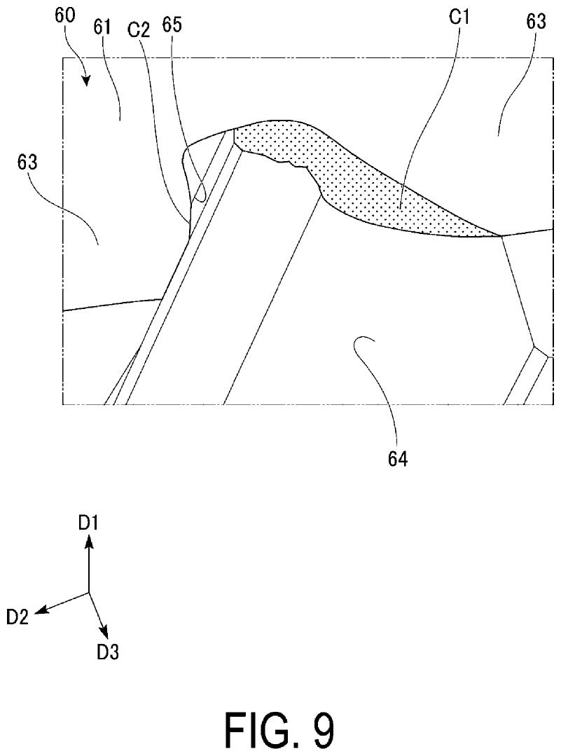

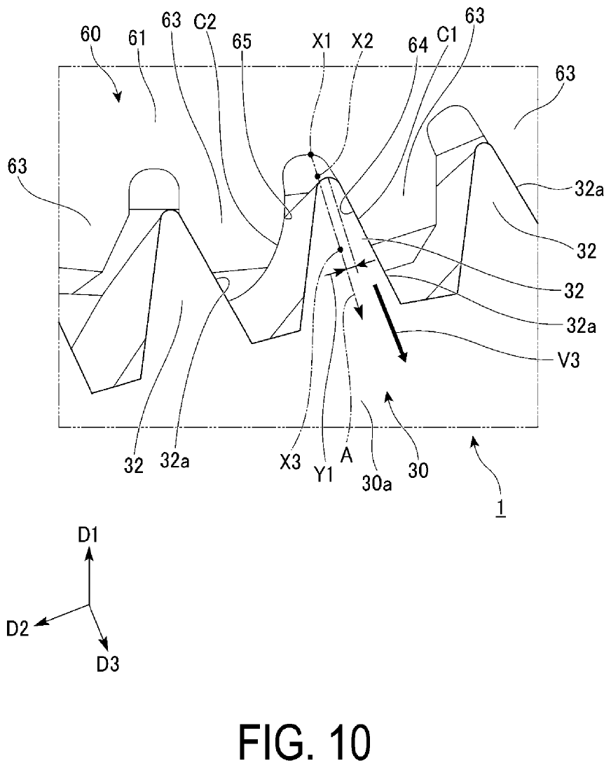

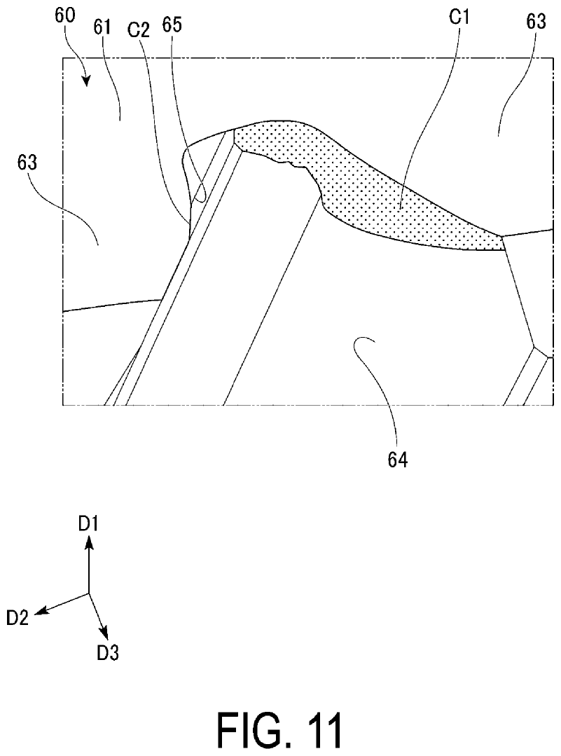

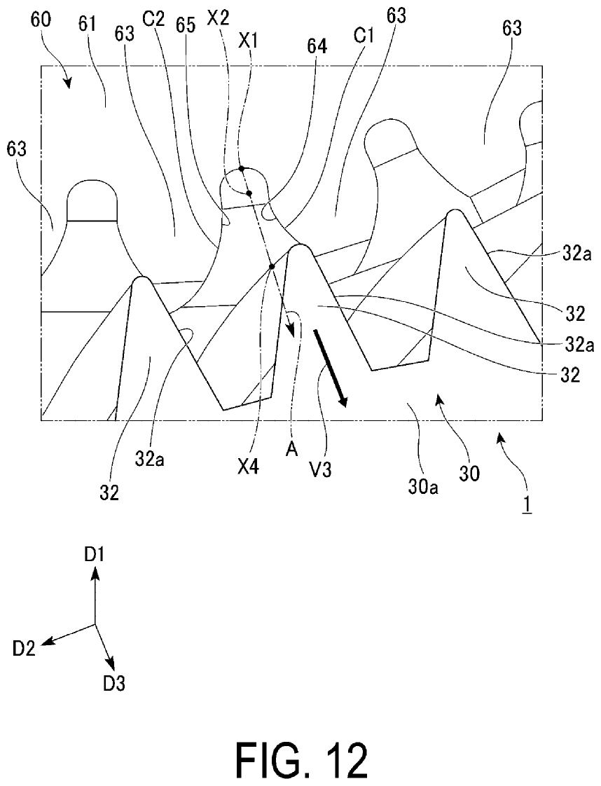

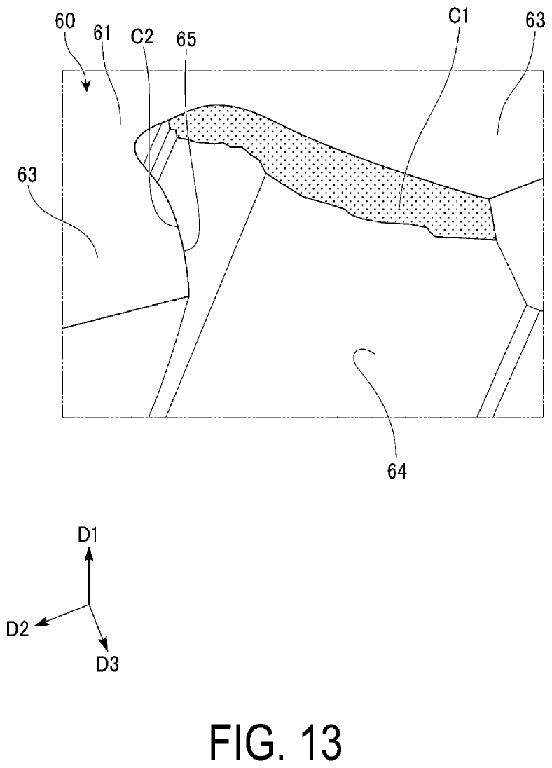

FIG. 6 is a second flowchart illustrating the gear machining method of the present embodiment. FIG. 7 includes timing charts showing the gear machining method of to the present embodiment. FIG. 8 is a first perspective view illustrating the gear machining method of the present embodiment. FIG. 9 is a first perspective view illustrating the gear 60 in the gear machining method of the present embodiment. FIG. 10 is a second perspective view illustrating the gear machining method of the present embodiment. FIG. 11 is a second perspective view illustrating the gear 60 in the gear machining method of the present embodiment. FIG. 12 is a third perspective view illustrating the gear machining method of the present embodiment. FIG. 13 is a third perspective view illustrating the gear 60 in the gear machining method of the present embodiment.

In the present embodiment, as described above, the first chamfering process P02, the second chamfering process P03, the third chamfering process P04, and the fourth chamfering process P05 are different from each other in the tools 30a, 30b, 30c, and 30d for performing the chamfering, and in the chamfered parts C1, C2, C3, and C4 of the plurality of tooth profiles 63, but the procedure for performing the chamfering is similar in each process. As illustrated in FIG. 6, each of the first chamfering process P02, the second chamfering process P03, the third chamfering process P04, and the fourth chamfering process P05 includes an adjusting process P11, an inserting process P12, a first machining process P13, and a second machining process P14. In the following description, the first chamfering process P02 of chamfering the first chamfered part C1 by the tool 30a will be described, but each of the second chamfering process P03, the third chamfering process P04, and the fourth chamfering process P05 of chamfering the chamfered parts C2, C3, and C4 by the tools 30b, 30c, and 30d, respectively, is performed in a similar procedure.

In the following description, a ratio of a rotation speed of the gear 60 to a rotation speed of the tool 30 is referred to as a rotation speed ratio Vr. In the following description, a moving speed of the tool 30 in the third direction D3 is referred to as a third moving speed V3. When the third moving speed V3 is a positive speed, the tool 30 moves to the one side (+D3 side) in the third direction D3, that is, to a side away from the gear 60. When the third moving speed V3 is a negative speed, the tool 30 moves to the other side (−D3 side) in the third direction D3, that is, to a side close to the gear 60. In the following description, a position of a leading end of the cutting edge 32 of the tool 30 in the third direction D3 is referred to as a leading end position X. In the following description, a first position X1, a second position X2, and a third position X3 are defined as positions on an arrow A in the third direction D3 extending in the third direction D3 illustrated in FIG. 8. The first position X1 is located at a tooth root of the tooth profile 63. When the leading end position X is located at the first position X1, the leading end of the cutting edge 32 is in contact with the tooth root of the tooth profile 63. The second position X2 is located on the one side in the third direction D3 with respect to the first position X1. The third position X3 is located on the one side in the third direction D3 with respect to the second position X2. As viewed from the first direction D1, the third position X3 overlaps a virtual circle (not illustrated) passing through a tooth tip of each tooth profile 63. When the leading end position X is located on the one side in the third direction D3 with respect to the third position X3, the cutting edge 32 is located on the one side in the third direction D3 with respect to the tooth profile 63. In the following description, a position of the leading end of the cutting edge 32 of the tool 30 in the second direction D2 is referred to as a leading end position Y.

In the adjusting process P11, the control unit 70 rotates the tool 30 and the gear 60 synchronously by matching a phase of rotation of the tool 30 with the phase of rotation of the gear 60. First, the control unit 70 moves each of the tool 30 and the phase sensor 26 to the other side (−D3 side) in the third direction D3 by each of the first drive mechanism, the second drive mechanism, and the third drive mechanism (not illustrated), and causes the phase sensor 26 to face the gear 60. Next, the control unit 70 rotates the gear 60 at a predetermined rotation speed by the first rotation mechanism (not illustrated). Next, the control unit 70 detects the phase of rotation of the gear 60 by the phase sensor 26. Next, the control unit 70 rotates the tool 30 by the fourth drive mechanism. At this time, the control unit 70 controls the rotation speed of the tool 30 based on a detection signal of the phase sensor 26. In particular, when the number of teeth of the tooth profiles 63 included in the gear 60 is N, and the number of spiral paths of the cutting edges 32 disposed side by side in the circumferential direction about the tool axis J1 among the cutting edges 32 included in the tool 30 is M, the control unit 70 rotates the tool 30 at an angular speed N/M times that of the gear 60. Thus, the control unit 70 synchronously rotates the tool 30 and the gear 60. The rotation speed ratio Vr when the tool 30 and the gear 60 synchronously rotate is a synchronous speed ratio Vs. When the control unit 70 synchronously rotates the tool 30 and the gear 60, the adjusting process P11 is ended.

A horizontal axis of each timing chart illustrated in FIG. 7 represents time t. When the time t is t0, the inserting process P12 described below is started. A vertical axis of the timing chart illustrated in FIG. 7(a) represents the rotation speed ratio Vr. A vertical axis of the timing chart illustrated in FIG. 7(b) represents the third moving speed V3. A vertical axis of the timing chart illustrated in FIG. 7(c) represents the leading end position X. A vertical axis of the timing chart illustrated in FIG. 7(d) represents the leading end position Y. Note that in the present embodiment, the leading end position Y is farther located on the other side (−D2 side) in the second direction D2 as a numerical value of the leading end position Y increases, and the leading end position Y is located farther on the one side (+D2 side) in the second direction D2 as the numerical value of the leading end position Y decreases.

In the inserting process P12, the control unit 70 inserts the cutting edge 32 of the tool 30 between the tooth profiles 63 of the gear 60 and moves the leading end position X to the first position X1. As illustrated in FIG. 7(c), the control unit 70 moves the tool 30 to the other side (−D3 side) in the third direction D3 by the first drive mechanism (not illustrated), and moves the leading end position X to the first position X1 as illustrated in FIG. 8 (t0 to t1 in FIG. 7(c)). At this time, as illustrated in FIG. 8, the cutting surface 32a facing the other side (−D2 side) in the second direction D2 comes into contact with a part of the first chamfered part C1 on the tooth root side. As illustrated in FIG. 7(b), the third moving speed V3 in the inserting process P12 is a negative speed V31. As illustrated in FIG. 7(a), in the present embodiment, the rotation speed ratio Vr in the inserting process P12 is the synchronous speed ratio Vs. Note that as illustrated in FIG. 7(d), in the present embodiment, the leading end position Y when the leading end position X is located at the first position X1 is defined as 0. When the control unit 70 moves the leading end position X to the first position X1, the inserting process P12 is ended.

In the first machining process P13, as illustrated in FIG. 7(a), the control unit 70 changes at least one of the rotation speed of the tool 30 and the rotation speed of the gear 60 by at least one of the fourth drive mechanism and the first rotation mechanism (not illustrated) at the time t1 to change the rotation speed ratio Vr to a first speed ratio Vr1 larger than the synchronous speed ratio Vs. That is, the control unit 70 changes the ratio of the rotation speed of the gear 60 to the rotation speed of the tool 30 by at least one of the tool drive unit 20 and the gear drive unit 40. As a result, as illustrated in FIG. 7(d), the leading end position Y moves to the other side (−D2 side) in the second direction D2. In the first machining process P13, the tool 30 moves to the other side in the second direction D2 with respect to the tooth profile 63, and thus the first chamfered part C1 can be chamfered by the cutting surface 32a. A hatched portion in FIG. 9 is a part to be chamfered at a time when the leading end position X is located at the first position X1.

As described above, in the present embodiment, each cutting surface 32a is linear. Additionally, as described above, in the present embodiment, the first chamfered part C1 has an involute curve shape. Therefore, as illustrated in FIG. 8, at the time when the leading end position X is located at the first position X1, a part of the cutting surface 32a on the one side (+D3 side) in the third direction D3 is in contact with the part of the first chamfered part C1 on the tooth root side, but a contact area between the cutting surface 32a and the first chamfered part C1 decreases as viewed toward the other side (−D3 side) in the third direction D3. Therefore, as illustrated in FIG. 9, at the time when the leading end position X is located at the first position X1, the part of the first chamfered part C1 on the tooth root side is chamfered into a predetermined shape. However, at the time when the leading end position X is located at the first position X1, a chamfer amount of the first chamfered part C1 decreases as viewed toward the tooth tip side. Therefore, a part of the first chamfered part C1 on the tooth tip side is not chamfered into a predetermined shape, and the chamfer amount of the first chamfered part C1 from the tooth root to the tooth tip of the tooth profile 63 is not uniform.

In the first machining process P13 of the present embodiment, as illustrated in FIG. 7(b), the control unit 70 switches the third moving speed V3 to a positive speed V32 by the first drive mechanism (not illustrated). Accordingly, the tool 30 moves to the one side (+D3 side) in the third direction D3 with respect to the gear 60. As illustrated in FIG. 7(c), the control unit 70 moves the tool 30 to the one side in the third direction D3 until the leading end position X moves to the second position X2 at a time t2. Thus, the control unit 70 changes a position of the tool 30 in the third direction D3 with respect to the gear 60 by the tool drive unit 20 while changing the rotation speed ratio Vr. Therefore, as illustrated in FIG. 10, the tool 30 moves to the other side (−D2 side) in the second direction D2 and the one side in the third direction D3 with respect to the gear 60. Thus, the control unit 70 can move the tool 30 so that the cutting surface 32a moves along a shape of the curved tooth profile 63. Therefore, a contact area between the cutting surface 32a and the part of the first chamfered part C1 on the tooth tip side can be increased. Therefore, as illustrated by a hatched portion in FIG. 11, a chamfer amount of the part of the first chamfered part C1 on the tooth tip side can be increased, so that uniformity of the chamfer amount of the first chamfered part C1 from the tooth root to the tooth tip of the tooth profile 63 can be enhanced. Note that as illustrated in FIG. 7(d) and FIG. 10, when the leading end position X reaches the second position X2, a movement amount of the leading end position Y to the other side in the second direction D2 is Y1.

In the second machining process P14, as illustrated in FIG. 7(a), the control unit 70 changes at least one of the rotation speed of the tool 30 and the rotation speed of the gear 60 by at least one of the fourth drive mechanism and the first rotation mechanism (not illustrated) at the time t2 to change the rotation speed ratio Vr to a second speed ratio Vr2 larger than the first speed ratio Vr1. That is, the control unit 70 changes the ratio of the rotation speed of the gear 60 to the rotation speed of the tool 30 by at least one of the tool drive unit 20 and the gear drive unit 40. As a result, as illustrated in FIG. 7(d), the leading end position Y moves to the other side (−D2 side) in the second direction D2. That is, the tool 30 moves to the other side in the second direction D2 with respect to the gear 60.

In addition, in the second machining process P14, as illustrated in FIG. 7(b), the control unit 70 switches the third moving speed V3 to a positive speed V33 having an absolute value larger than that of the speed V32 by the first drive mechanism (not illustrated) at the time t2. As a result, as illustrated in FIG. 7(c), the leading end position X moves to the third position X3 at a time t3. Therefore, in the second machining process P14, the control unit 70 changes the position of the tool 30 in the third direction D3 with respect to the gear 60 by the tool drive unit 20 while changing the rotation speed ratio Vr. Therefore, as in the first machining process P13 described above, the control unit 70 can move the tool 30 so that the cutting surface 32a moves along the shape of the curved tooth profile 63. Therefore, as illustrated in FIG. 12, the contact area between the cutting surface 32a and the part of the first chamfered part C1 on the tooth tip side can be more suitably increased. This makes it possible to achieve uniformity of the contact area between the cutting surface 32a and the first chamfered part C1 from the tooth root to the tooth tip in the first machining process P13 and the second machining process P14. Therefore, as illustrated by a hatched portion in FIG. 13, the chamfer amount of the part of the first chamfered part C1 on the tooth tip side can be increased, and thus the uniformity of the chamfer amount of the first chamfered part C1 from the tooth root to the tooth tip of the tooth profile 63 can be achieved. Accordingly, the first chamfered part C1 can be chamfered into a predetermined shape from the tooth root to the tooth tip. Note that as illustrated in FIG. 7(d), when the leading end position X reaches the third position X3, the movement amount of the leading end position Y to the other side (−D2 side) in the second direction D2 is Y2.

As illustrated in FIG. 7(c), when the control unit 70 moves the leading end position X to the one side (+D3 side) in the third direction D3 with respect to the third position X3, the second machining process P14 is ended. When the second machining process P14 is ended, the first chamfering process P02 is ended. Thereafter, the control unit 70 performs the adjusting process P11, the inserting process P12, the first machining process P13, and the second machining process P14 described above in each of the second chamfering process P03, the third chamfering process P04, and the fourth chamfering process P05 illustrated in FIG. 5. When the fourth chamfering process P05 is ended, the control unit 70 performs the above-described carrying-out process P06. When the carrying-out process P06 is ended, the chamfering of the gear 60 is ended.

Note that the gear machining method described above is an example, and the gear machining method is not limited to the present embodiment. For example, the first speed ratio Vr1 may be a speed ratio larger than the second speed ratio Vr2, or the first speed ratio Vr1 and the second speed ratio Vr2 may be the same speed ratio. In addition, in the first machining process P13, the rotation speed ratio Vr may linearly increase from the synchronous speed ratio Vs to the first speed ratio Vr1. In the second machining process P14, the rotation speed ratio Vr may linearly increase from the first speed ratio Vr1 to the second speed ratio Vr2. Further, the speed V32 may be higher than the speed V33, or the speed V32 and the speed V33 may be the same speed. In addition, in the first machining process P13, the third moving speed V3 may linearly increase from the speed V31 to the speed V32. In the second machining process P14, the third moving speed V3 may linearly increase from the speed V32 to the speed V33. Each of the rotation speed ratio Vr and the third moving speed V3 can be appropriately set according to the shape of the tooth profile 63, a predetermined chamfer amount, and the like.

In addition, in the first machining process P13 and the second machining process P14, the control unit 70 may move the tool 30 in the first direction D1 without moving the tool 30 in the third direction D3. Even in this case, a position where the cutting surface 32a of the tool 30 comes into contact with the tooth profile 63 can be moved in the third direction D3. Therefore, the tool 30 can be moved so that the cutting surface 32a moves along the shape of each of the curved chamfered parts C1, C2, C3, and C4, and therefore, the uniformity of the chamfer amount of the chamfered part from the tooth root to the tooth tip of the tooth profile 63 can be achieved.

According to the present embodiment, the machine tool 1 is the machine tool that chamfers the plurality of tooth profiles 63 included in the gear 60, and includes the tool 30 including the plurality of cutting edges 32, the gear drive unit 40 that holds the gear 60 so as to be rotatable about the gear axis J2 extending in the first direction D1, the tool drive unit 20 that holds the tool 30 so as to be rotatable about the tool axis J1 extending in the second direction D2, and the control unit 70 that controls the operation of each of the tool drive unit 20 and the gear drive unit 40, the gear 60 and the tool 30 face each other in the third direction D3, the tool drive unit 20 can move the tool 30 in the third direction D3, in the first machining process P13 and the second machining process P14, that is, when the tooth profile 63 is chamfered, the control unit 70 changes the position of the tool 30 in the third direction D3 with respect to the gear 60 by the tool drive unit 20, while changing the rotation speed ratio Vr, that is, the ratio of the rotation speed of the gear 60 to the rotation speed of the tool 30, by at least one of the tool drive unit 20 and the gear drive unit 40. Therefore, as described above, the control unit 70 can move the tool 30 in each of the second direction D2 and the third direction D3 with respect to the gear 60 so that the cutting surface 32a of the tool 30 moves along the shape of the tooth profile 63. Therefore, in the present embodiment, the uniformity of the contact area between the cutting surface 32a included in the cutting edge 32 and the chamfered part can be achieved from the tooth root to the tooth tip as described above, regardless of the shape of the tooth profile 63. Therefore, as described above, in the present embodiment, the uniformity of the chamfer amount from the tooth root to the tooth tip of the tooth profile 63 can be achieved. Accordingly, in the present embodiment, the chamfered part can be chamfered into a predetermined shape from the tooth root to the tooth tip.

According to the present embodiment, the tool 30 is the hob cutter. Therefore, as described above, since the tool 30 includes the plurality of cutting edges 32 along the second direction D2, for example, when the number of gears 60 chamfered by the tool 30 reaches a predetermined number, a meshing position can be shifted by moving the tool 30 in the second direction D2. This makes it possible to achieve uniformity of loads for the respective cutting edges 32. Therefore, endurance performance of the tool 30 can be enhanced as compared with a case where the tool 30 is a cutting tool such as a chamfer cutter, a fly cutter, or an end mill having a small number of the cutting edges 32 in the second direction D2. The tool 30 may be a chamfer cutter, and according to the present example, the uniformity of the chamfer amount from the tooth root to the tooth tip of the tooth profile 63 can be achieved. Note that the chamfer cutter is a chamfering tool of a forming type in which one cutting edge is provided for each of a plurality of spirals.

According to the present embodiment, each of the plurality of cutting edges 32 includes the cutting surface 32a that comes into contact with the tooth profile 63, and the cutting surface 32a is linear. As described above, in the present embodiment, the control unit 70 can move the tool 30 in each of the second direction D2 and the third direction D3 with respect to the gear 60 so that the cutting surface 32a of the tool 30 moves along the shape of the tooth profile 63. Therefore, in the present embodiment, even when the cutting surface 32a of the cutting edge 32 is linear, the contact area between the cutting surface 32a and the uniformity of the chamfered part from the tooth root to the tooth tip can be achieved as described above. Therefore, as described above, in the present embodiment, even when the cutting surface 32a is linear, the uniformity of the chamfer amount from the tooth root to the tooth tip of the tooth profile 63 can be achieved.

In a case of chamfering the gear 60 by the tool 30 in which a shape of the cutting surface 32a is a curved shape matched with the shape of the tooth profile 63, when the gear 60 in which the tooth profile 63 has a different shape and a different predetermined chamfer amount is chamfered, it is necessary to newly create the tool 30 to have a shape of the cutting surface 32a matched with the shape of the tooth profile 63 and the predetermined chamfer amount. On the other hand, in the present embodiment, as described above, chamfering can be performed by a predetermined chamfer amount by moving the tool 30 in each of the second direction D2 and the third direction D3 with respect to the gear 60 so that the cutting surfaces 32a of the tool 30 moves along the shape of the tooth profile 63. Therefore, even when chamfering the gear 60 in which the tooth profile 63 has a different shape and a different predetermined chamfer amount, the uniformity of the chamfer amount from the tooth root to the tooth tip of the tooth profile 63 can be achieved by the single tool 30. Therefore, when chamfering the gear 60 in which the tooth profile 63 has a different shape and a different predetermined chamfer amount, it is not necessary to create a new tool 30, and thus it is possible to suppress an increase in machining costs of the gear 60.

According to the present embodiment, the machine tool 1 includes the plurality of tools 30 disposed side by side along the second direction D2, the tool drive unit 20 holds the plurality of tools 30 so as to be rotatable about the tool axis J1, and the plurality of tools 30 respectively chamfer the chamfered parts C1, C2, C3, and C4 of the tooth profile 63 different from each other, that is, the parts of the tooth profile 63 different from each other. The shapes of the respective chamfered parts C1, C2, C3, and C4 are different from each other, and further, the chamfer amounts predetermined in the respective chamfered parts C1, C2, C3, and C4 are different from each other, in some cases. In this case, in the present embodiment, orientations of the cutting surfaces 32a included in the respective tools 30 can be set to orientations suitable for chamfering the chamfered parts C1, C2, C3, and C4 different from each other. Therefore, in the present embodiment, the chamfered parts C1, C2, C3, and C4 can be chamfered by the respective tools 30 having the cutting surfaces 32a suitable for chamfering the respective chamfered parts C1, C2, C3, and C4. Therefore, as compared with a case where the respective chamfered parts C1, C2, C3, and C4 are chamfered by one tool 30, the uniformity of the chamfer amount from the tooth root to the tooth tip of the each of the chamfered parts C1, C2, C3, and C4 can be suitably achieved. Thus, each of the chamfered parts C1, C2, C3, and C4 can be chamfered from the tooth root to the tooth tip by a predetermined chamfer amount.

According to the present embodiment, the gear machining method is the gear machining method that chamfers the plurality of tooth profiles 63 included in the gear 60 by the machine tool 1 including the tool 30 including the plurality of cutting edges 32, the gear drive unit 40 that holds the gear 60 so as to be rotatable about the gear axis J2 extending in the first direction D1, the tool drive unit 20 that holds the tool 30 so as to be rotatable about the tool axis J1 extending in the second direction D2, and the control unit 70 that controls the operation of each of the tool drive unit 20 and the gear drive unit 40, the gear 60 and the tool 30 face each other in the third direction D3, and the control unit 70 changes the position of the tool 30 in the third direction D3 with respect to the gear 60 by the tool drive unit 20, while changing the rotation speed ratio Vr, that is, the ratio of the rotation speed of the gear 60 to the rotation speed of the tool 30, by at least one of the tool drive unit 20 and the gear drive unit 40. As described above, in the present embodiment, the control unit 70 can move the tool 30 in each of the second direction D2 and the third direction D3 with respect to the gear 60 so that the cutting surface 32a of the tool 30 moves along the shape of the tooth profile 63. Therefore, in the present embodiment, the uniformity of the chamfer amount from the tooth root to the tooth tip of the tooth profile 63 can be achieved. Accordingly, in the present embodiment, the chamfered part can be chamfered into a predetermined shape from the tooth root to the tooth tip of the tooth profile 63.

### Modification of Embodiment

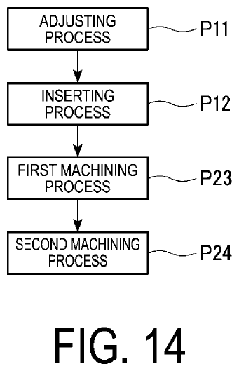

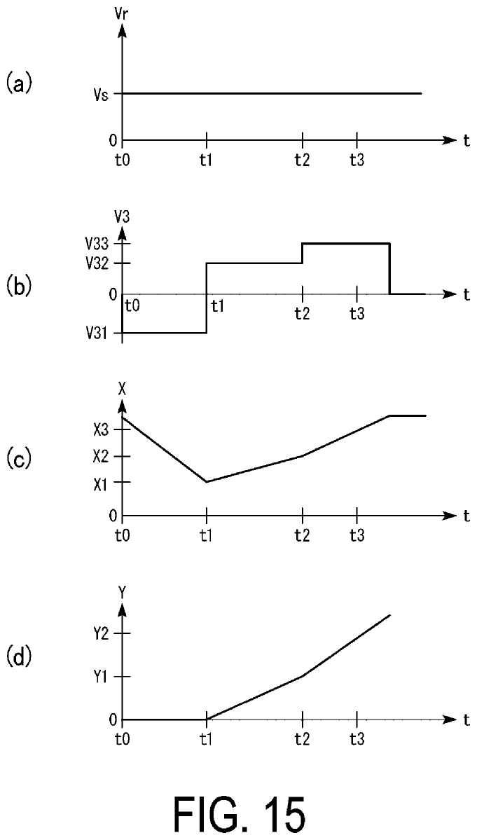

FIG. 14 is a flowchart illustrating the gear machining method of the present modification. FIG. 15 includes timing charts showing the gear machining method of the present modification. A configuration and the like of the machine tool 1 of the present modification are similar to the configuration and the like of the machine tool 1 of the embodiment described above. Thus, the tool drive unit 20 can move the tool 30 in both the second direction D2 and the third direction D3. In the following description, components similar to those of the embodiment described above are denoted by the same reference signs, and description thereof will be omitted.

The gear machining method of the present modification is a machining method of chamfering the plurality of tooth profiles 63 included in the gear 60 which is a workpiece by the machine tool 1. The gear machining method of the present modification, as in the gear machining method of the embodiment described above, includes the carrying-in process P01, the first chamfering process P02, the second chamfering process P03, the third chamfering process P04, the fourth chamfering process P05, and the carrying-out process P06 (see FIG. 5). In the gear machining method of the present modification, each of the first chamfering process P02, the second chamfering process P03, the third chamfering process P04, and the fourth chamfering process P05 includes the adjusting process P11, the inserting process P12, a first machining process P23, and a second machining process P24 illustrated in FIG. 14.

In the adjusting process P11, the control unit 70 rotates the tool 30 and the gear 60 synchronously by matching the phase of rotation of the tool 30 with the phase of rotation of the gear 60. Operation and the like of each unit of the machine tool 1 in the adjusting process P11 of the present modification are similar to the operation and the like of each unit of the machine tool 1 in the adjusting process P11 of the embodiment described above.

A horizontal axis of each timing chart in FIG. 15 represents time t. The inserting process P12 is started at a time t0. A vertical axis of the timing chart illustrated in FIG. 15(a) represents the rotation speed ratio Vr. A vertical axis of the timing chart illustrated in FIG. 15(b) represents the third moving speed V3. A vertical axis of the timing chart illustrated in FIG. 15(c) represents the leading end position X. A vertical axis of the timing chart illustrated in FIG. 15(d) represents the leading end position Y. Operation and the like of each unit of the machine tool 1 in the inserting process P12 of the present modification are similar to the operation and the like of each unit of the machine tool 1 in the inserting process P12 of the embodiment described above.

As illustrated in FIG. 15(a), in the first machining process P23 (a time t1 to a time t2) and the second machining process P24 (the time t2 to a time t3) of the present modification, the control unit 70 maintains the rotation speed ratio Vr at the synchronous speed ratio Vs. In the first machining process P23 of the present modification, the control unit 70 moves the tool 30 to the other side (−D2 side) in the second direction D2 with respect to the gear 60 by the third drive mechanism (not illustrated). As a result, as illustrated in FIG. 15(d), the leading end position Y moves to the other side in the second direction D2. In the first machining process P23, the tool 30 moves to the other side in the second direction D2 with respect to the tooth profile 63, and thus the first chamfered part C1 can be chamfered by the cutting surface 32a. The control unit 70 moves the tool 30 to the other side in the second direction D2 until the leading end position Y moves to Y1 at the time t2.

In addition, in the first machining process P23 of the present modification, as illustrated in FIG. 15(b), the control unit 70 switches the third moving speed V3 to the positive speed V32 by the first drive mechanism (not illustrated). Accordingly, the tool 30 moves to the one side (+D3 side) in the third direction D3 with respect to the gear 60. As illustrated in FIG. 15(c), the control unit 70 moves the tool 30 to the one side in the third direction D3 until the leading end position X moves to the second position X2 at the time t2. Thus, in the first machining process P23, the control unit 70 changes a position in the second direction D2 and a position in the third direction D3 of the tool 30 with respect to the gear 60 by the tool drive unit 20. Therefore, in the present modification, the control unit 70 can move the tool 30 so that the cutting surface 32a moves along the shape of the curved tooth profile 63, as in the above-described embodiment. Therefore, as in the embodiment described above, the uniformity of the chamfer amount of the first chamfered part C1 from the tooth root to the tooth tip of the tooth profile 63 can be enhanced (see FIG. 11).

In the second machining process P24 of the present modification, the control unit 70 moves the tool 30 to the other side (−D2 side) in the second direction D2 with respect to the gear 60 by the third drive mechanism (not illustrated). As a result, as illustrated in FIG. 15(d), the leading end position Y moves to the other side in the second direction D2. That is, the tool 30 moves to the other side in the second direction D2 with respect to the gear 60. The control unit 70 moves the tool 30 to the other side in the second direction D2 until the leading end position Y moves to Y2 at the time t3.

In addition, in the second machining process P24 of the present modification, as illustrated in FIG. 15(b), the control unit 70 switches the third moving speed V3 to the positive speed V33 having the absolute value larger than that of the speed V32 by the first drive mechanism (not illustrated) at the time t2. As a result, as illustrated in FIG. 15(c), the leading end position X moves to the third position X3 at the time t3. Thus, in the second machining process P24, the control unit 70 changes the position in the second direction D2 and the position in the third direction D3 of the tool 30 with respect to the gear 60 by the tool drive unit 20. Therefore, as in the first machining process P23 described above, the control unit 70 can move the tool 30 so that the cutting surfaces 32a moves along the shape of the curved tooth profile 63. Therefore, in the present modification, as in the embodiment described above, the uniformity of the chamfer amount of the first chamfered part C1 from the tooth root to the tooth tip of the tooth profile 63 can be achieved (see FIG. 13). Accordingly, in the present modification, the first chamfered part C1 can be chamfered into a predetermined shape from the tooth root to the tooth tip of the tooth profile 63.

As illustrated in FIG. 15(c), when the control unit 70 moves the leading end position X to the one side (+D3 side) in the third direction D3 with respect to the third position X3, the second machining process P24 is ended. When the second machining process P24 is ended, the first chamfering process P02 is ended. Thereafter, the control unit 70 performs the adjusting process P11, the inserting process P12, the first machining process P23, and the second machining process P24 described above in each of the second chamfering process P03, the third chamfering process P04, and the fourth chamfering process P05. When the fourth chamfering process P05 is ended, the control unit 70 performs the above-described carrying-out process P06. When the carrying-out process P06 is ended, the chamfering of the gear 60 is ended.

Note that the gear machining method described above is an example, and the gear machining method is not limited to the present modification. For example, the rotation speed ratio Vr in each of the first machining process P23 and the second machining process P24 need not be the same speed ratio as the synchronous speed ratio Vs. Further, the speed V32 may be higher than the speed V33, or the speed V32 and the speed V33 may be the same speed. In addition, in the first machining process P23, the third moving speed V3 may linearly increase from the speed V31 to the speed V32. In the second machining process P24, the third moving speed V3 may linearly increase from the speed V32 to the speed V33.

In addition, in the first machining process P23 and the second machining process P24, the control unit 70 may move the tool 30 in the first direction D1 without moving the tool 30 in the third direction D3. Even in this case, the position where the cutting surface 32a of the tool 30 comes into contact with the tooth profile 63 can be moved in the third direction D3. Therefore, the tool 30 can be moved so that the cutting surface 32a moves along the shape of each of the curved chamfered parts C1, C2, C3, and C4, and therefore, the uniformity of the chamfer amount of the chamfered part from the tooth root to the tooth tip of the tooth profile 63 can be achieved.

According to the present modification, the machine tool 1 is the machine tool that chamfers the plurality of tooth profiles 63 included in the gear 60, and includes the tool 30 including the plurality of cutting edges 32, the gear drive unit 40 that holds the gear 60 so as to be rotatable about the gear axis J2 extending in the first direction D1, the tool drive unit 20 that holds the tool 30 so as to be rotatable about the tool axis J1 extending in the second direction D2, and the control unit 70 that controls the operation of each of the tool drive unit 20 and the gear drive unit 40, the gear 60 and the tool 30 face each other in the third direction D3, the tool drive unit 20 can move the tool 30 in both the second direction D2 and the third direction D3, in the first machining process P23 and the second machining process P24, that is, when an end surface of the tooth profile 63 is chamfered, the control unit 70 changes each of the position in the second direction D2 and the position in the third direction D3 of the tool 30 with respect to the gear 60 by the tool drive unit 20. Therefore, as described above, the control unit 70 can move the tool 30 in each of the second direction D2 and the third direction D3 with respect to the gear 60 so that the cutting surface 32a of the tool 30 moves along the shape of the tooth profile 63. Therefore, in the present modification, the uniformity of the contact area between the chamfered part and the cutting surface 32a included in the cutting edge 32 can be achieved from the tooth root to the tooth tip, regardless of the shape of the tooth profile 63. Therefore, as described above, in the present modification, the uniformity of the chamfer amount from the tooth root to the tooth tip of the tooth profile 63 can be achieved. Accordingly, in the present modification, the chamfered part can be chamfered into a predetermined shape from the tooth root to the tooth tip of the tooth profile 63.

According to the present modification, the gear machining method is the gear machining method that chamfers the plurality of tooth profiles 63 included in the gear 60 by the machine tool 1 including the tool 30 including the plurality of cutting edges 32, the gear drive unit 40 that holds the gear 60 so as to be rotatable about the gear axis J2 extending in the first direction D1, the tool drive unit 20 that holds the tool 30 so as to be rotatable about the tool axis J1 extending in the second direction D2, and the control unit 70 that controls the operation of each of the tool drive unit 20 and the gear drive unit 40, in which the gear 60 and the tool 30 face each other in the third direction D3, the tool drive unit 20 can move the tool 30 in both the second direction D2 and the third direction D3, and the control unit 70 changes each of the position in the second direction D2 and the position in the third direction D3 of the tool 30 with respect to the gear 60 by the tool drive unit 20. Therefore, as described above, in the present modification, the control unit 70 can move the tool 30 in each of the second direction D2 and the third direction D3 with respect to the gear 60 so that the cutting surface 32a of the tool 30 moves along the shape of the tooth profile 63. Therefore, the uniformity of the chamfer amount from the tooth root to the tooth tip of the tooth profile 63 can be achieved. Accordingly, in the present modification, the chamfered part can be chamfered into a predetermined shape from the tooth root to the tooth tip of the tooth profile 63.

While the embodiments of the present disclosure have been described above, the configurations in the embodiments, combinations thereof, and the like are an example, and additions, omissions, substitutions, and other modifications of the configurations can be made without departing from the spirit of the present disclosure. Furthermore, the present disclosure is not limited to the embodiments.

Note that the present technology can have configurations such as the following.
(1) A machine tool that chamfers a plurality of tooth profiles included in a gear, including a tool including a plurality of cutting edges, a gear drive unit configured to hold the gear so as to be rotatable about a gear axis extending in a first direction, a tool drive unit configured to hold the tool so as to be rotatable about a tool axis extending in a second direction intersecting the first direction, and a control unit configured to control operation of each of the tool drive unit and the gear drive unit, in which the gear and the tool face each other in a third direction intersecting both the first direction and the second direction, the tool drive unit can move the tool in the third direction, and when chamfering the tooth profile, the control unit changes a position of the tool in the third direction with respect to the gear by the tool drive unit while changing a ratio of a rotation speed of the gear to a rotation speed of the tool by at least one of the tool drive unit and the gear drive unit.
(2) A machine tool that chamfers a plurality of tooth profiles included in a gear, including a tool including a plurality of cutting edges, a gear drive unit configured to hold the gear so as to be rotatable about a gear axis extending in a first direction, a tool drive unit configured to hold the tool so as to be rotatable about a tool axis extending in a second direction intersecting the first direction, and a control unit configured to control operation of each of the tool drive unit and the gear drive unit, in which the gear and the tool face each other in a third direction intersecting both the first direction and the second direction, the tool drive unit can move the tool in both the second direction and the third direction, and when chamfering an end surface of the tooth profile, the control unit changes each of a position in the second direction and a position in the third direction of the tool with respect to the gear by the tool drive unit.
(3) The machine tool according to (1) or (2), in which the tool is a hob cutter, or a chamfering tool of a forming type including a plurality of spirals each including one of the cutting edges.
(4) The machine tool according to any one of (1) to (3), in which each of the plurality of cutting edges includes a cutting surface that comes into contact with the tooth profile, and the cutting surface is linear.
(5) The machine tool according to any one of (1) to (4) including a plurality of the tools disposed side by side along the second direction, in which the tool drive unit holds the plurality of tools so as to be rotatable about the tool axis, and the plurality of tools chamfer parts of the tooth profile different from each other, respectively.
(6) A gear machining method that chamfers a plurality of tooth profiles included in a gear by a machine tool including a tool including a plurality of cutting edges, a gear drive unit that holds the gear so as to be rotatable about a gear axis extending in a first direction, a tool drive unit that holds the tool so as to be rotatable about a tool axis extending in a second direction intersecting the first direction, and a control unit that controls operation of each of the tool drive unit and the gear drive unit, in which the gear and the tool face each other in a third direction intersecting both the first direction and the second direction, and the control unit changes a position in the third direction of the tool with respect to the gear by the tool drive unit while changing a ratio of a rotation speed of the gear to a rotation speed of the tool by at least one of the tool drive unit and the gear drive unit.
(7) A gear machining method that chamfers a plurality of tooth profiles included in a gear by a machine tool including a tool including a plurality of cutting edges, a gear drive unit that holds the gear so as to be rotatable about a gear axis extending in a first direction, a tool drive unit that holds the tool so as to be rotatable about a tool axis extending in a second direction intersecting the first direction, and a control unit that controls operation of each of the tool drive unit and the gear drive unit, in which the gear and the tool face each other in a third direction intersecting both the first direction and the second direction, the tool drive unit can move the tool in both the second direction and the third direction, and the control unit changes each of a position in the second direction and a position in the third direction of the tool with respect to the gear by the tool drive unit.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A machine tool that chamfers a plurality of tooth profiles included in a gear, comprising:
a tool including a plurality of cutting edges;
a gear drive unit configured to hold the gear so as to be rotatable about a gear axis extending in a first direction;
a tool drive unit configured to hold the tool so as to be rotatable about a tool axis extending in a second direction intersecting the first direction; and
a control unit configured to control operation of each of the tool drive unit and the gear drive unit, wherein
the gear and the tool face each other in a third direction intersecting both the first direction and the second direction,
the tool drive unit can move the tool in the third direction, and
when chamfering the tooth profile, the control unit changes a position of the tool in the third direction with respect to the gear by the tool drive unit while changing a ratio of a rotation speed of the gear to a rotation speed of the tool by at least one of the tool drive unit and the gear drive unit.

2. A machine tool that chamfers a plurality of tooth profiles included in a gear, comprising:
a tool including a plurality of cutting edges;
a gear drive unit configured to hold the gear so as to be rotatable about a gear axis extending in a first direction;
a tool drive unit configured to hold the tool so as to be rotatable about a tool axis extending in a second direction intersecting the first direction; and
a control unit configured to control operation of each of the tool drive unit and the gear drive unit, wherein
the gear and the tool face each other in a third direction intersecting both the first direction and the second direction,
the tool drive unit can move the tool in both the second direction and the third direction, and
when chamfering an end surface of the tooth profile, the control unit changes each of a position in the second direction and a position in the third direction of the tool with respect to the gear by the tool drive unit.

3. The machine tool according to claim 1, wherein
the tool is a hob cutter, or a chamfering tool of a forming type including a plurality of spirals each including one of the cutting edges.

4. The machine tool according to claim 1, wherein
each of the plurality of cutting edges includes a cutting surface that comes into contact with the tooth profile, and
the cutting surface is linear.

5. The machine tool according to claim 1 comprising a plurality of the tools disposed side by side along the second direction, wherein
the tool drive unit holds the plurality of tools so as to be rotatable about the tool axis, and
the plurality of tools chamfer parts of the tooth profile different from each other, respectively.

6. A gear machining method that chamfers a plurality of tooth profiles included in a gear by a machine tool including a tool including a plurality of cutting edges, a gear drive unit that holds the gear so as to be rotatable about a gear axis extending in a first direction, a tool drive unit that holds the tool so as to be rotatable about a tool axis extending in a second direction intersecting the first direction, and a control unit that controls operation of each of the tool drive unit and the gear drive unit, wherein
the gear and the tool face each other in a third direction intersecting both the first direction and the second direction, and
the control unit changes a position in the third direction of the tool with respect to the gear by the tool drive unit while changing a ratio of a rotation speed of the gear to a rotation speed of the tool by at least one of the tool drive unit and the gear drive unit.

7. A gear machining method that chamfers a plurality of tooth profiles included in a gear by a machine tool including a tool including a plurality of cutting edges, a gear drive unit that holds the gear so as to be rotatable about a gear axis extending in a first direction, a tool drive unit that holds the tool so as to be rotatable about a tool axis extending in a second direction intersecting the first direction, and a control unit that controls operation of each of the tool drive unit and the gear drive unit, wherein
the gear and the tool face each other in a third direction intersecting both the first direction and the second direction,
the tool drive unit can move the tool in both the second direction and the third direction, and
the control unit changes each of a position in the second direction and a position in the third direction of the tool with respect to the gear by the tool drive unit.
